(19) United States
(12) Patent Application Publication
(10) Pub. No.: US 2016/0111118 A1
(43) Pub. Date: Apr. 21, 2016

(54) MAGNETIC HEAD, HEAD GIMBAL ASSEMBLY INCLUDING THE SAME, AND DISK DEVICE

(71) Applicant: KABUSHIKI KAISHA TOSHIBA, Tokyo (JP)

(72) Inventor: Tomomi FUNAYAMA, Fuchu Tokyo (JP)

(21) Appl. No.: 14/722,610

(22) Filed: May 27, 2015

(30) Foreign Application Priority Data
Apr. 24, 2014 (JP) 2014-090457

(51) Int. Cl. G11B 5/48; G11B 5/17; G11B 5/127; G11B 5/60

(52) U.S. Cl. CPC G11B 5/4853; G11B 5/6005; G11B 5/4826; G11B 5/17; G11B 5/1278; G11B 2005/0024

(57) ABSTRACT

A magnetic head includes a main magnetic pole that applies a recording magnetic field to a recording layer of a recording medium, a recording coil that generates a magnetic field in the main magnetic pole, a microwave oscillator that is disposed in a vicinity of the main magnetic pole, a first wiring electrically connected to recording coil, a second wiring electrically connected to the microwave oscillator, and a low pass filter that is electrically connected to the second wiring.

### CROSS-REFERENCE TO RELATED APPLICATION

This application is based upon and claims the benefit of priority from Japanese Patent Application No. 2014-090457, filed Apr. 24, 2014, the entire contents of which are incorporated herein by reference.

### BACKGROUND

Recently, a magnetic head for perpendicular magnetic recording has been proposed in order to provide high recording density, large capacity, and miniaturization of a magnetic disk device. In such a magnetic head, a recording head includes a main magnetic pole that generates a perpendicular magnetic field, a write shield which is disposed on a trailing side of the main magnetic pole with a write gap therebetween and closes a magnetic path with a magnetic disk, and a coil for causing a magnetic flux to flow through the main magnetic pole. Further, a magnetic recording head for microwave assisted recording has been proposed, in which a microwave oscillator is disposed between a main magnetic pole and a write shield (i.e., in the write gap between the main magnetic pole and the write shield).

In order for the microwave oscillator to oscillate stably, it is necessary to prevent noise such as crosstalk from being superposed on a driving current of the microwave oscillator. For example, a method has been proposed in which wirings for applying a bias voltage to the microwave oscillator, such wirings being included in a plurality of wirings connected to a magnetic head, are distributed to both sides of a suspension. As a result, high-frequency components are prevented from being mixed into the wirings of the microwave oscillator due to crosstalk.

In the magnetic recording head configured in such a manner, it is possible to reduce a certain degree of high-frequency components (i.e., crosstalk noise) from being mixed. However, it becomes difficult to sufficiently reduce the mixing of high-frequency components when an overshoot is applied to a recording current, when a recording frequency becomes high, and the like. For this reason, the bias voltage of the microwave oscillator fluctuates, and an oscillating operation of an oscillator becomes unstable, and thus a high-frequency magnetic field sufficient for microwave assisted recording is not obtained.

### DESCRIPTION OF THE DRAWINGS

FIG. 1 is a perspective view illustrating a hard disk drive (HDD) according to a first embodiment.

FIG. 2 is a plan view illustrating an arm and a head gimbal assembly of the HDD.

FIG. 3 is an enlarged perspective view of a tip portion of the head gimbal assembly.

FIG. 4 is a cross-sectional view of the tip portion of the head gimbal assembly and a magnetic disk.

FIG. 5 is a schematic diagram of a low pass filter of the head gimbal assembly.

FIG. 6 is an enlarged cross-sectional view of a head unit of a magnetic head.

FIG. 7A is a schematic diagram illustrating a low pass filter according to a first modification example.

FIG. 7B is a schematic diagram illustrating a low pass filter according to a second modification example.

FIG. 8 is a diagram illustrating a frequency characteristic of the low pass filter, according to the first embodiment.

FIG. 9 is a diagram illustrating frequency components, of crosstalk noise in a magnetic head that does not include a low pass filter, according to a comparative example.

FIG. 10 is a schematic front view illustrating a magnetic head of an HDD according to a second embodiment.

FIG. 11 is a perspective view illustrating a process of forming a head unit of the magnetic head and a low pass filter, according to the second embodiment.

FIGS. 12-20 are perspective views, each of which illustrates one or more steps in a process of forming a reproducing head of the head unit and the low pass filter, according to one or more embodiments.

FIG. 21 is a diagram illustrating frequency characteristics of the low pass filter, according to the second embodiment.

FIG. 22 is a schematic front view of a magnetic head of an HDD according to a third embodiment.

FIG. 23 is a diagram illustrating frequency characteristics of a low pass filter, according to the third embodiment.

### DETAILED DESCRIPTION

Embodiments described herein provide a microwave assist type magnetic head capable of preventing the mixing of high-frequency noise in order to oscillate stably, a head gimbal assembly including the magnetic head, and a disk device.

In general, according to one embodiment, a magnetic head of a disk device includes a main magnetic pole that applies a recording magnetic field to a recording layer of a recording medium, a recording coil that generates a magnetic field in the main magnetic pole, a microwave oscillator that is disposed in a vicinity of the main magnetic pole, a first wiring electrically connected to the recording coil, a second wiring electrically connected to the microwave oscillator, and a low pass filter that is electrically connected to the second wiring.

Hereinafter, various embodiments are described with reference to the accompanying drawings.

### First Embodiment

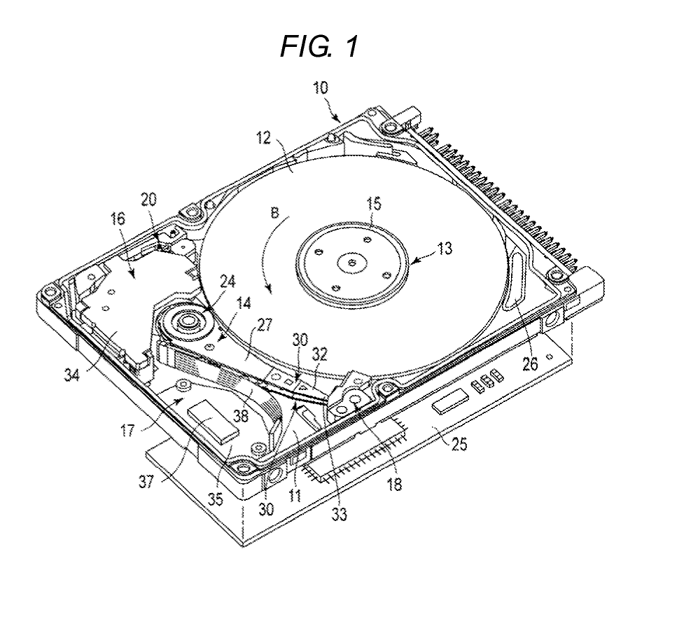

FIG. 1 illustrates an internal structure of a hard disk drive (HDD) according to a first embodiment, where a top cover of the HDD is removed. As illustrated in FIG. 1, the HDD includes a housing 10. The housing 10 includes a rectangular box-shaped base 11, the top surface of which is exposed, and a rectangular plate-shaped top cover (which is not illustrated). The top cover is threadably mounted on the base 11 using a plurality of screws to close an upper end opening of the base 11. Thus, the inside of the housing 10 is maintained in an airtight manner, and is capable of communicating with the outside only through an aeration filter 26.

A magnetic disk 12 as a recording medium and a mechanism unit are provided on the base 11. The mechanism unit (driving unit) includes a spindle motor 13 that supports and rotates the magnetic disk 12, a plurality of, for example, two magnetic heads 33 that perform recording and reproducing of information on the magnetic disk 12, a head stack assembly (HSA) 14 that movably supports the magnetic heads 33 with respect to the surface of the magnetic disk 12, and a voice coil motor (VCM) 16 that rotates and positions the HSA 14. In addition, a ramp load mechanism 18 that holds the magnetic heads 33 at positions separated from the magnetic disk 12 when the magnetic heads 33 move to an outermost periphery of the magnetic disk 12, a latching mechanism 20 that holds the HSA 14 at a retraction position when an impact or the like is applied to the HDD, and a circuit board unit 17 having electronic components such as a conversion connector 37 mounted thereon are provided on the base 11.

A control circuit board 25 is threadably mounted on an outer surface of the base 11 and faces a bottom wall of the base 11. The control circuit board 25 controls operations of the spindle motor 13, the VCM 16, and the magnetic head 33 through the circuit board unit 17.

As illustrated in FIG. 1, the magnetic disk 12 is formed to have a diameter of, for example, 65 mm (2.5 inches) and has a magnetic recording layer on the upper surface and the lower surface thereof. The magnetic disk 12 is coaxially fitted to a hub of the spindle motor 13, and is clamped by a clamp spring 15 and is fixed to the hub. The magnetic disk 12 is rotated by the spindle motor 13 as a driving motor in the direction of arrow B at a predetermined speed.

The HSA 14 includes a bearing portion 24 which is fixed to the bottom wall of the base 11, a plurality of two or more arms 27 extending from the bearing portion 24, and head gimbal assemblies (HGAs) 30 extending from the respective arms 27. The arms 27 are located in parallel with the surface of the magnetic disk 12 at a predetermined interval, and extend in the same direction from the bearing portion 24. Each HGA 30 includes an elongated plate-shape suspension 32 extending from the corresponding arm 27, and the magnetic head 33, which is supported by an extended end of the suspension 32 through a gimbal to be described later. The HGAs 30 that are attached to the two arms 27 face each other with the magnetic disk 12 interposed therebetween.

As illustrated in FIG. 1, the circuit board unit 17 includes an FPC main body 35 formed of a flexible printed circuit board (FPC), and a main FPC 38 extending from the FPC main body 35. The FPC main body 35 is fixed onto the bottom surface of the base 11. Electronic components such as the conversion connector 37 are mounted on the FPC main body 35. An extended end of the main FPC 38 is connected to the bearing portion 24 of the HSA 14 and is electrically connected to the magnetic head 33 through a flexure (i.e., a wiring member) to be described later.

The VCM 16 includes a voice coil supported by a supporting frame (not illustrated in the drawing) of the HSA 14, a pair of yokes 34 fixed onto the base 11, and magnets fixed to the yokes 34. The voice coil is disposed between the yoke 34 and the magnet.

The HSA 14 is rotated by electrifying the voice coil of the VCM 16 while the magnetic disk 12 is rotating, and the magnetic heads 33 are moved and positioned onto a desired track of the magnetic disk 12. At this time, the magnetic heads 33 are moved between an inner peripheral edge and an outer peripheral edge of the magnetic disk along a radial direction of the magnetic disk 12.

Next, the HGA 30 and the magnetic head 33 will be described in detail.

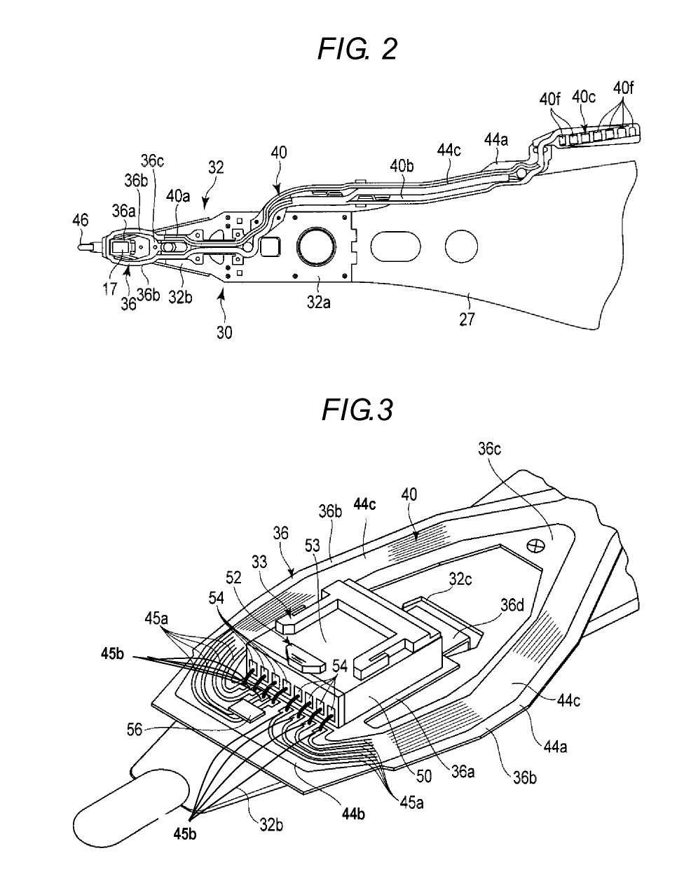

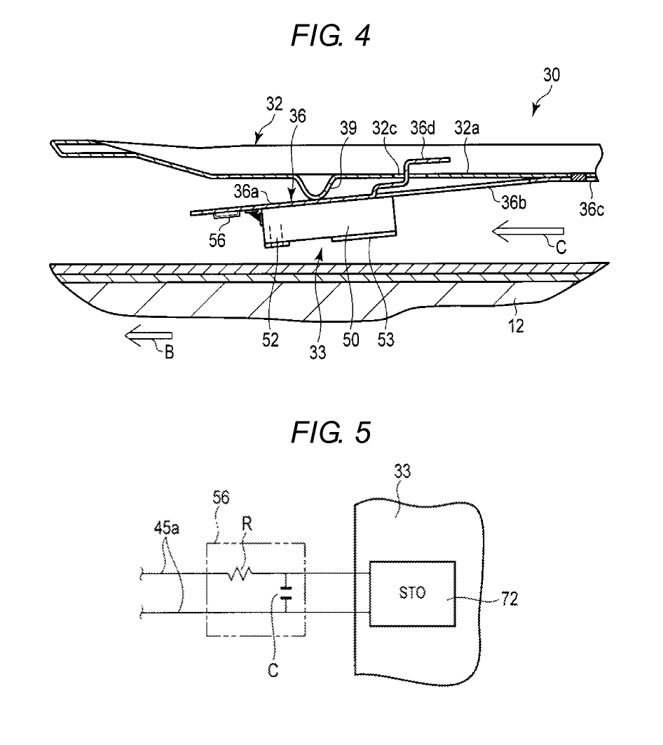

FIG. 2 is a plan view illustrating the arm and the HGA, FIG. 3 is an enlarged perspective view illustrating a magnetic head portion of the HGA, and FIG. 4 is a cross-sectional view of a suspension tip portion.

As illustrated in FIG. 2, the HGA 30 has an elongated plate-shape suspension 32, which functions as a supporting plate. For example, the suspension 32 includes a base plate 32a fixed to the arm 27 and a flat spring-shaped load beam 32b extending from the base plate. Moreover, the suspension 32 may be integrally formed with the arm 27.

The HGA 30 includes an elongated band-shaped flexure (a wiring member or wiring trace) 40 for transmitting recording and reproducing signals of the magnetic heads 33, a bias voltage of a microwave oscillator (which is described later), and a driving signal for a heater. In the flexure 40, a tip side portion 40a is attached onto the load beam 32b and the base plate 32a, a latter portion (i.e., an extended portion) 40b extends to the outside from a side edge of the base plate 32a and extends along a side edge of the arm 27. A connection end 40c of the flexure 40 located at the tip of the extended portion 40b is connected to the main FPC 38 via connection pads 40f.

A tip portion of the flexure 40 located on the tip portion of the load beam 32b configures a gimbal portion 36, and the magnetic heads 33 are mounted on the gimbal portion 36. That is, the magnetic heads 33 are fixed onto the gimbal portion 36 and are supported by the load beams 32b through the gimbal portion 36.

As illustrated in FIGS. 2 to 4, the flexure 40 includes a thin metal plate (i.e., a backing layer) 44a, such as stainless steel, which serves as a base, an insulating layer 44b formed on the thin metal plate 44a, a conductive layer (i.e., a wiring pattern) 44c which is formed on the insulating layer 44b and configures a plurality of wirings 45a, and a protection layer (or insulating layer, not shown in the drawing), which covers the conductive layer 44c. The flexure forms an elongated band-shaped laminated plate. In the tip side portion 40a of the flexure 40, the thin metal plate 44a side is attached or spot-welded onto the surfaces of the load beam 32b and the base plate 32a.

In the gimbal portion 36 of the flexure 40, the thin metal plate 44a includes a flat rectangular-shaped head mounting portion 36a, a link portion 36b extending in a bifurcated shape from the head mounting portion 36a toward the base end side of the arm 27, and a band-shaped fixation portion 36c extending from the link portion 36b toward the base end side of the arm 27. The head mounting portion 36a faces the tip portion of the load beam 32b with a gap therebetween, and is located so that the central axis thereof is substantially aligned with the central axis of the load beam 32b. The link portions 36b extend from both sides of the head mounting portion 36a with a gap therebetween. The fixation portion 36c is fixed to the load beam 32b by, for example, spot welding.

In the gimbal portion 36, the insulating layer 44b and the conductive layer 44c of the flexure 40 are divided in a bifurcated shape, pass above the link portion 36b, and extend up to the vicinity of the head mounting portion 36a. In this embodiment, eight wirings 45a are provided, and four of the wirings 45a pass above the link portion 36b on each side and extend up to the vicinity of the head mounting portion 36a. Further, a connection pad 40f is formed in an extended end of each of the wirings 45a, and eight connection pads are disposed in the vicinity of the head mounting portion 36a so as to be lined up in a row. As illustrated in FIG. 2, the plurality of wirings 45a extend to the connection ends 40c of the flexure along the flexure 40, and are connected to the plurality of connection pads 40f provided in the respective connection ends 40c, respectively.

As illustrated in FIGS. 3 and 4, the gimbal portion 36 includes a limiter 36d extending from the head mounting portion 36a. The limiter 36d extends to the upper surface side of the load beam 32b via a through hole 32c formed in the load beam 32b. The limiter 36d abuts against the load beam 32b when the head mounting portion 36a is substantially moved toward the magnetic disk 12, and regulates excessive movement of the head mounting portion 36a.

In the load beam 32b, a dimple, shown in FIG. 4 as a substantially hemispherical protrusion 39 and which protrudes to the magnetic head side, is formed at a position facing the head mounting portion 36a of the gimbal portion 36 (i.e., at a position facing the central portion of the magnetic head 33). The protrusion 39 abuts against the head mounting portion 36a at a back side of the magnetic head 33. The head mounting portion 36a is elastically pressed against the protrusion 39 by the elasticity of the link portion 36b. The head mounting portion 36a and the magnetic head 33 may be displaced in a pitch direction and a rolling direction around the protrusion 39 by the elastic deformation of the link portion 36b, as well as in a vertical direction.

As illustrated in FIGS. 2 to 4, the magnetic head 33 is fixed to the head mounting portion 36a of the gimbal portion 36. The magnetic head 33 is configured as a floating type head, and includes a slider 50 formed to have a substantially rectangular parallelepiped shape and a head unit 52 formed in an end on an outflow end (or trailing) side of the slider. The slider 50 is formed of, for example, a sintered body of alumina and titanium carbide (AlTiC), and the head unit 52 is formed by laminating thin films. The slider 50 has a disk facing surface (i.e., an air bearing surface (ABS)) 53 facing the magnetic disk 12 and a back face on the opposite side of the ABS 53. The slider 50 is formed to have a size corresponding to the head mounting portion 36a, and the back face thereof is affixed, in this embodiment, to the head mounting portion 36a.

As will be described later, the head unit 52 includes a magnetic recording head, a magneto-resistive (MR) element that functions as a reproducing head, a microwave oscillator, and a heater. As shown in FIG. 3, a plurality of eight electrode pads 54 are provided in an end face on the trailing side of the slider 50. The electrode pads 54 are electrically connected to the magnetic recording head, the reproducing head, the microwave oscillator, and the heater, respectively, through wirings provided within the slider 50. In addition, the electrode pads 54 are located adjacent to the connection pads of the flexure 40, and are electrically connected to the corresponding connection pads (i.e., the wirings 45a shown in FIG. 3) using solder, bonding wires, or the like.

As illustrated in FIGS. 3 and 4, according to this embodiment, a low pass filter 56 is mounted on the gimbal portion 36. The low pass filter 56 is connected to two wirings 45a that supply a driving voltage to the spin torque oscillator (STO) (i.e., microwave oscillator), among the plurality of wirings 45a, and is disposed in the vicinity of the magnetic head 33. As illustrated in FIG. 5, the low pass filter 56 is configured to include, in this embodiment, a capacitor C and a resistor R.

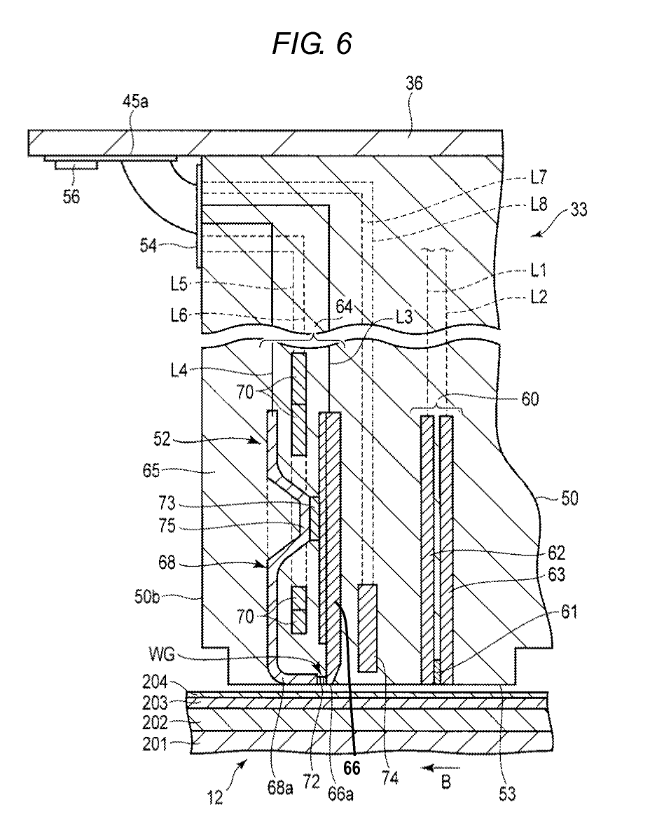

FIG. 6 is an enlarged cross-sectional view of the head unit 52 of the magnetic head 33 and a portion of the magnetic disk 12. As illustrated in this diagram, the magnetic disk 12 includes a substrate 201 which is formed to have a disk shape, and which is formed of a non-magnetic material. A soft magnetic layer 202 serves as a base layer, and is formed of a material having a soft magnetic characteristic. A magnetic recording layer 203 is located on the soft magnetic layer 202, and has magnetic anisotropy in a direction perpendicular to a disk surface, and a protection layer 204 is located on the magnetic recording layer 203. Each of the soft magnetic layer 202, the magnetic recording layer 203, and the protection layer 204 is laminated in order on the surface of the substrate 201.

As illustrated in FIG. 6, the head unit 52 is formed as a separation-type magnetic head and includes a reproducing head 60 and a recording head (i.e., a magnetic recording head) 64, which are formed in a trailing end 50b of the slider 50 by a thin-film process. The reproducing head 60 and the recording head 64 are covered by a protection insulating film 65, except for portions exposed by the disk facing surface (i.e., the ABS) 53 of the slider 50. The protection insulating film 65 forms a contour of the head unit 52.

The reproducing head 60 includes a magneto-resistive film 61 that exhibits a magneto-resistance effect, and shield layers 62 and 63, which are disposed on the trailing side and the leading side of the magneto-resistive film 61 with the magneto-resistive film 61 interposed therebetween. Lower ends of the magneto-resistive film 61 and the shield layers 62 and 63 are exposed by the ABS 53 of the slider 50. The reproducing head 60 is electrically connected to two corresponding electrode pads 54 by two wirings L1 and L2.

The recording head 64 is provided on the trailing end 50b of the slider 50 with respect to the reproducing head 60. The recording head 64 includes a main magnetic pole 66 formed of a soft magnetic material having a high saturation magnetic flux density, a write shield 68 which is formed of a soft magnetic material disposed on the trailing side of the main magnetic pole 66, a recording coil 70, which is disposed so as to wind around a magnetic core (magnetic circuit) including the main magnetic pole 66 and the write shield 68 in order to cause a magnetic flux to flow through the main magnetic pole 66, and a microwave oscillation element, for example, a spin torque oscillator (STO) 72, formed of magnetic and non-magnetic conductors, which is disposed between a tip portion 66a of the main magnetic pole 66 on the ABS 53 side and the write shield 68 and which is disposed in a portion facing the ABS 53. The main magnetic pole 66 generates a recording magnetic field in a direction perpendicular to the surface of the magnetic disk 12 in order to magnetize the magnetic recording layer 203 of the magnetic disk 12. The write shield 68 is provided to efficiently close a magnetic path through the soft magnetic layer 202 located just below the main magnetic pole 66.

The main magnetic pole 66 extends substantially perpendicular to the surface of the magnetic disk 12 and the ABS 53. A tip portion 66a of the main magnetic pole 66 on the magnetic disk 12 side narrows in a tapering manner toward the ABS 53, and is formed in a trapezoidal shape having a narrower width than other portions of the main magnetic pole 66. A tip face of the main magnetic pole 66 is exposed by the ABS 53 of the slider 50.

The write shield 68 is formed to have a substantially L shape, and has a tip portion 68a facing the tip portion 66a of the main magnetic pole 66. The tip portion 68a of the write shield 68 is formed to have an elongated rectangular shape. A tip face of the write shield 68 is exposed by the ABS 53 of the slider 50. A leading side end face of the tip portion 68a faces the tip portion 66a of the main magnetic pole 66 in parallel with a write gap (WG) therebetween. The write shield 68 includes a connection portion 75 at a position separated from the ABS 53. The connection portion 75 is magnetically connected to the top of the main magnetic pole 66 through a non-conductor 73.

The main magnetic pole 66 and the write shield 68 are electrically connected to two corresponding electrode pads 54 through wirings L3 and L4. The main magnetic pole 66 and the write shield 68 also function as electrodes for electrifying the spin torque oscillator 72.

In the embodiment shown in FIG. 6, the recording coil 70 is provided between the main magnetic pole 66 and the write shield 68. The recording coil 70 is electrically connected to the corresponding two electrode pads 54 through two wirings L5 and L6. The two electrode pads 54 are connected to a power supply of the HDD through the above-described flexure 40. A current supplied from the power supply to the recording coil 70 is controlled by the control circuit board 25 of the HDD. When a signal is written on the magnetic disk 12, a predetermined current is supplied from the power supply to the recording coil 70, which causes a magnetic flux to flow through the main magnetic pole 66 to generate a magnetic field.

As illustrated in FIG. 6, the spin torque oscillator 72 is provided within the write gap WG between the tip portion 66a of the main magnetic pole 66 and the leading side end face of the write shield 68. The spin torque oscillator 72 is configured to include a base layer, a spin injection layer, an intermediate layer, an oscillation layer, and capping layer, which are laminated in order. At least a lower end of the oscillation layer is exposed by the ABS 53. The spin torque oscillator 72 is electrically connected to the main magnetic pole 66 and the write shield 68. Thus, a circuit is configured which transmits a current in series through the main magnetic pole 66, the spin torque oscillator 72, and the write shield 68. When the spin torque oscillator 72 is electrified through the wirings 45a of the flexure 40, the low pass filter 56, the wirings L3 and L4, the main magnetic pole 66, and the write shield 68 from the power supply of the HDD, the magnetic moments of the oscillation layer oscillates to generate a high-frequency magnetic field. The high-frequency magnetic field is applied to the magnetic recording layer 203 of the magnetic disk 12.

At this time, the current supplied to the spin torque oscillator 72 through the wirings 45a of the flexure 40 is transmitted to the spin torque oscillator 72 after crosstalk noise is removed by the low pass filter 56. For this reason, a bias voltage of the spin torque oscillator 72 may be maintained in a stable state without being affected by the crosstalk noise, regardless of a recording frequency of the recording head 64, and, as a result, the spin torque oscillator 72 may stably oscillate.

As illustrated in the embodiment of FIG. 6, the magnetic head 33 includes a heater 74 for controlling the amount of floating of the magnetic head 33. The heater 74 is formed of a metal conductor, such as Ta, W, or Mo, and is formed to have a rectangular columnar shape. In embodiments, the heater 74 is provided on the leading side of the main magnetic pole 66 and along the main magnetic pole 66. The heater 74 is electrically connected to two corresponding electrode pads 54 through wirings L7 and L8.

When the heater 74 is electrified through the wirings 45a of the flexure 40, the electrode pads 54, and the wirings L7 and L8, the temperature of the heater 74 rises and heats the vicinity thereof. Then, the tip portion 66a and the main magnetic pole 66 thermally expand on the magnetic disk 12 side, thereby making it possible to adjust an interval between the ABS 53 and the surface of the magnetic disk 12, i.e., the amount of floating of the magnetic head.

According to the HDD configured in the above-described manner, the HSA 14 is rotated by driving the VCM 16, and the magnetic heads 33 move onto a desired track of the magnetic disk 12 to be positioned. In addition, the magnetic heads 33 float by an air flow C generated between the disk surface and the ABS 53 due to the rotation of the magnetic disk 12. During the operation of the HDD, the ABS 53 of the slider 50 faces the disk surface with a gap therebetween. As illustrated in FIG. 4, the magnetic heads 33 float while taking an inclined posture in which the portion of the recording head 64 of the head unit 52 is closest to the surface of the magnetic disk 12. In this state, the read-out and writing of recording information from and on the magnetic disk 12 are performed using the reproducing head 60 and the recording head 64, respectively.

In the writing of the information, as illustrated in FIG. 6, a direct current is transmitted to the main magnetic pole 66, the spin torque oscillator 72, and the write shield 68 through the wirings 45a of the flexure 40, the low pass filter 56, the electrode pads 54, and the wirings L3 and L4 within the slider 50 from the power supply to generate a high-frequency magnetic field from the spin torque oscillator 72. The high-frequency magnetic field is applied to the magnetic recording layer 203 of the magnetic disk 12. In addition, an alternate current is applied to the recording coil 70 through the wirings 45a of the flexure 40, the electrode pads 54, and the wirings L5 and L6 within the slider 50 from the power supply to excite the main magnetic pole 66, and a perpendicular recording magnetic field is applied to the recording layer 203 of the magnetic disk 12, which is located just below the main magnetic pole. Thus, information is recorded on the magnetic recording layer 203 in a desired track width. The high-frequency magnetic field is superposed on the recording magnetic field, and thus it is possible to perform magnetic recording with a high coercive force and high magnetic anisotropy energy.

According to the first embodiment, a crosstalk noise (i.e., high-frequency noise) may be removed using the low pass filter 56 connected to the spin torque oscillator 72, and the bias voltage of the spin torque oscillator 72 may be maintained in a stable state without being affected by the crosstalk noise. Thus, the spin torque oscillator 72 may stably oscillate.

When a high-frequency recording current or overshoot of a recording current is applied, a crosstalk noise becomes greater as the frequency becomes higher and as a time change becomes rapid. For this reason, a noise voltage, which is superposed on the spin torque oscillator 72, becomes higher as the voltage has higher frequency components. It is possible to effectively remove the components having a high frequency, and, thus, a substantial amount of noise, using the low pass filter 56, which is electrically connected to the spin torque oscillator 72.

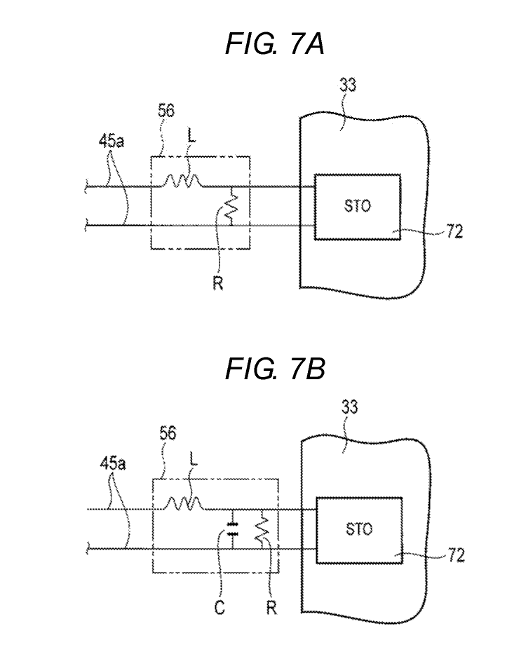

The low pass filter 56 is not limited to a combination of the resistor R and the capacitor C illustrated in FIG. 5. The low pass filter may be configured with an inductor L and the resistor R as illustrated in FIG. 7A, or may be configured with a combination of the inductor L, the capacitor C, and the resistor R as illustrated in FIG. 7B. In addition, the low pass filter 56 may be configured with, in embodiments, a combination of an operational amplifier, a capacitor, and a resistor.

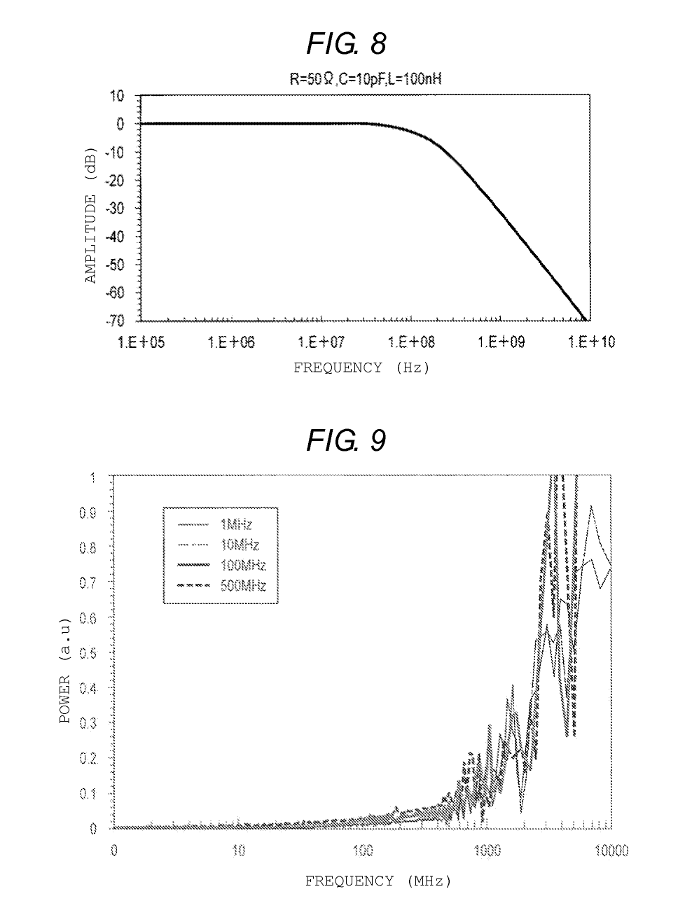

FIG. 8 illustrates a frequency characteristic of the low pass filter 56 including the inductor L, the capacitor C, and the resistor R illustrated in FIG. 7B. Values of the resistor R, capacitor C, and inductor L are R=50Ω, C=10 pF, and L=100 nH, respectively. Referring to FIG. 8, it may be seen that a cut-off frequency fc of the low pass filter 56 is equal to or less than 100 MHz.

In a magnetic head that does not include a low pass filter, where crosstalk noise from a wiring for a recording current to a wiring for driving a spin torque oscillator is measured when changing a frequency of the recording current to range from 1 to 500 MHz, a Fourier analysis produces results such as those illustrated in FIG. 9. Referring to FIG. 9, in any recording current frequency, it may be seen that the crosstalk noise has frequency components of equal to or greater than 500 MHz which are high.

In the first embodiment, the cut-off frequency fc of the low pass filter 56 is equal to or less than 100 MHz. Accordingly, in the magnetic head according to this embodiment, it is possible to drastically reduce the crosstalk noise of the wirings for electrifying the spin torque oscillator by using the low pass filter 56. The crosstalk noise from the wirings for a recording current is measured in the wirings between the low pass filter 56 and the spin torque oscillator, and the crosstalk noise is reduced to a level which is almost unobservable. From this, the cut-off frequency fc of the low pass filter 56 is set equal to or less than 500 MHz or, preferably, equal to or less than 100 MHz.

As described above, according to the first embodiment, it is possible to obtain a microwave assist type magnetic head capable of preventing the mixing of high-frequency noise into a microwave oscillator, regardless of a recording frequency of a recording head, and capable of stably oscillating and recording, a head gimbal assembly that includes the magnetic head, and a disk device.

Next, a magnetic head of an HDD according to another embodiment will be described. In the embodiment described below, the same components as those in the first embodiment previously described will be denoted by the same reference numerals, and detailed description thereof will be omitted. A detailed description is made with respect to parts different from those in the first embodiment.

In the first embodiment described above, the low pass filter 56 is provided on the gimbal portion 36 in the vicinity of the magnetic head 33, but is not limited thereto. The low pass filter may be provided inside the magnetic head 33.

### Second Embodiment

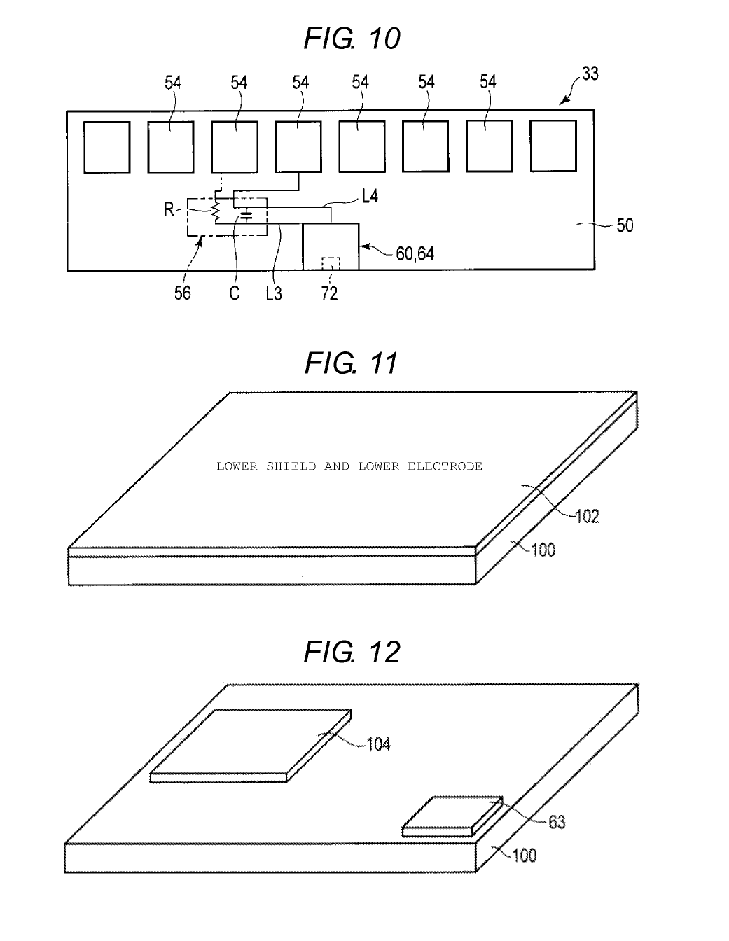

FIG. 10 schematically illustrates a magnetic head of an HDD according to a second embodiment. According to this embodiment, a low pass filter 56 is formed within a slider 50 of a magnetic head 33. A plurality of electrode pads 54 are provided at an end of the slider 50 on a trailing side. The magnetic head 33 includes a reproducing head 60, a recording head 64, and a spin torque oscillator 72, and the spin torque oscillator 72 is electrically connected to the electrode pads 54 through wirings L3 and L4. The low pass filter 56 is formed between the spin torque oscillator 72 and the electrode pads 54 within the slider 50. In this embodiment, the low pass filter 56 includes a capacitor C and a resistor R, and is connected to the wirings L3 and L4.

The resistor R and the capacitor C included in the low pass filter 56 are fabricated in a wafer process carried out when creating a head unit of the magnetic head 33. For example, facing upper and lower electrodes of the capacitor C are formed of the same layers as two shield layers of the reproducing head 60, and a dielectric layer of the capacitor C is formed of the same layer as an insulating film of the reproducing head 60. In addition, the resistor R is formed of the same layer as a conductive metal layer configuring a heater.

An example of a method of forming the low pass filter 56 will be described. When the reproducing head 60 and a floating control heater are formed on an AlTiC substrate 100 of a head unit on which alumina is deposited, a capacitor and a resistor comprising a low pass filter are collectively formed.

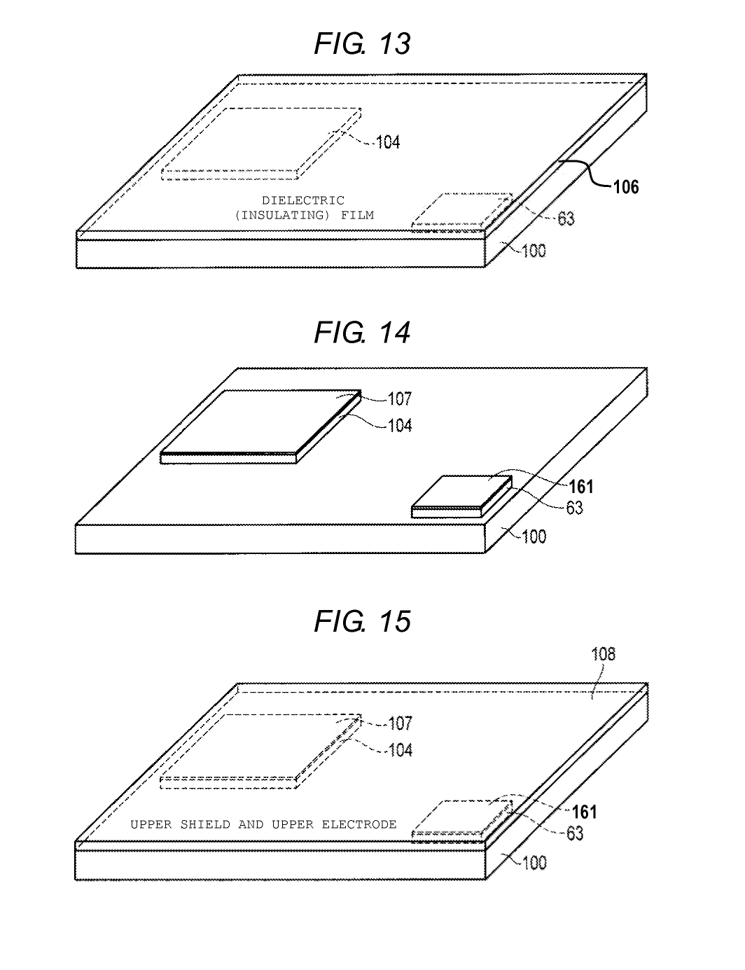

As illustrated in FIG. 11, a shield layer 102 formed of, in embodiments; NiFe is formed on the surface of the substrate 100. Subsequently, as illustrated in FIG. 12, the shield layer 102 is patterned to form a lower shield layer 63 of the reproducing head and a lower electrode 104 of the capacitor C. An insulating film (i.e., dielectric film) 106 formed of, in embodiments, alumina, is formed on the substrate 100 so as to overlap the lower shield layer 63 and the lower electrode 104, as illustrated in FIG. 13, and then the insulating film 106 is patterned so that the lower shield layer 63 and the lower electrode 104 remain, as illustrated in FIG. 14. Thus, a insulating film 161 is formed on the lower shield layer 63, and a dielectric layer 107 is formed on the lower electrode 104.

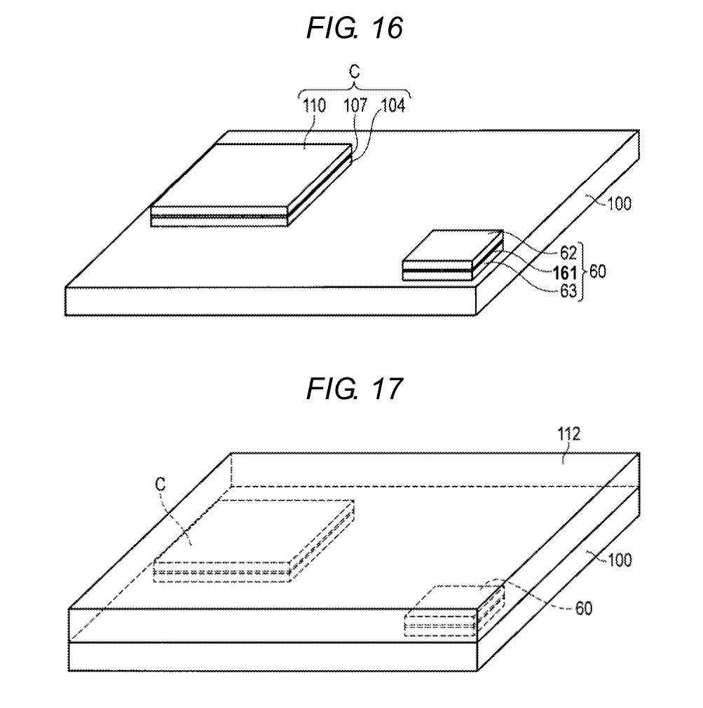

Next, a shield layer 108 formed of, in embodiments, NiFe is formed on the substrate 100 so as to overlap the insulating film 161 and the dielectric layer 107, as illustrated in FIG. 15, and then the shield layer 108 is patterned to form an upper shield layer 62 and an upper electrode 110 on the insulating film 161 and the dielectric layer 107, respectively, as illustrated in FIG. 16. Thus, the reproducing head 60 and the capacitor C are simultaneously formed. (Fabricating process of TMR (Tunnel Magneto-Resistance) sensor is omitted.)

The capacity of the capacitor C formed in this manner is 50 pF. When a material having a dielectric constant different from that of alumina, for example, SiO₂, HfO₂, HfSiO₂, or BaTiO₃ is used for the material of the dielectric layer, only the portion of the dielectric layer 107 may be deposited separately from the portion of the reproducing head.

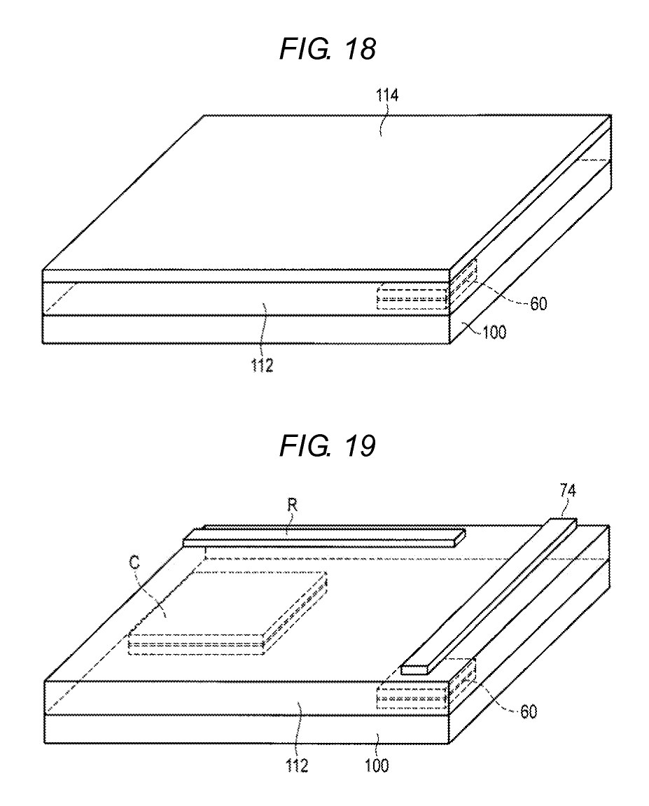

Subsequently, as illustrated in FIG. 17, an insulating layer 112 is formed on the entire surface of the substrate 100 so as to overlap the reproducing head 60 and the capacitor C, and the surface is planarized. As illustrated in FIG. 18, a resistive film (conductive metal layer) 114 is formed on the insulating layer 112. A conductive metal such as Ta, W, Mo, or NiCr is used for the resistive film 114. Next, as illustrated in FIG. 19, the resistive film 114 is patterned to form a heater 74 for controlling the amount of floating and the resistor R of the low pass filter. The resistor R formed in this manner is 50Ω.

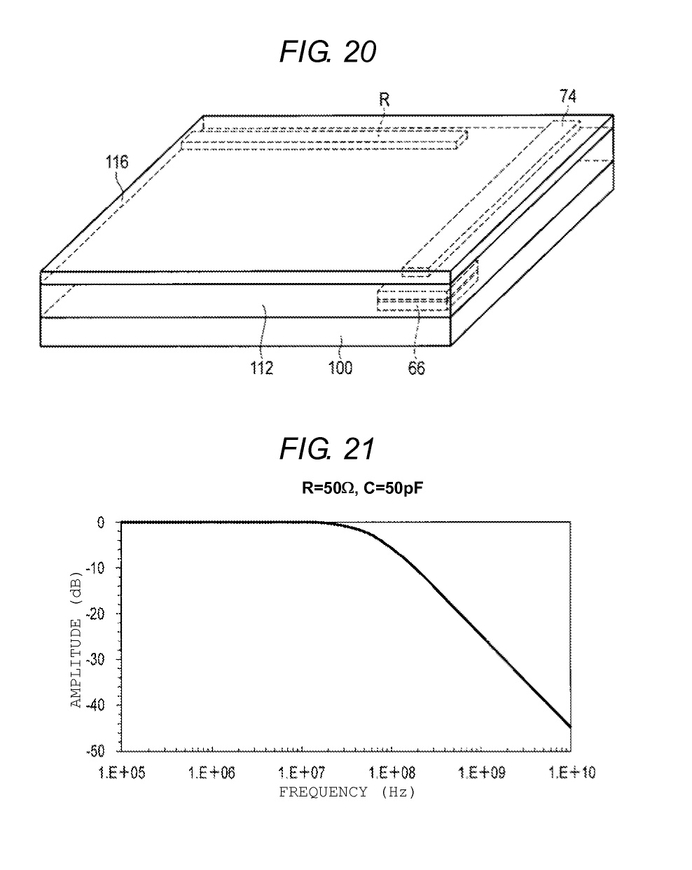

As illustrated in FIG. 20, an insulating layer 116 is formed on the insulating layer 112 so as to overlap the heater 74 and the resistor R, and the surface is planarized. Next, a main magnetic pole 66, a recording coil 70, the spin torque oscillator 72, and a write shield 68 are sequentially formed on the insulating layer 116. Thereafter, the main magnetic pole 66 and the write shield 68, serving as electrodes of the spin torque oscillator 72, are electrically connected to the corresponding electrode pads 54 using the wirings L3 and L4. At the same time, the capacitor C and the resistor R of the low pass filter 56 are connected to the wirings L3 and L4.

A frequency characteristic of the low pass filter 56 formed in the above-described manner is evaluated. Then, a frequency characteristic illustrated in FIG. 21 is obtained, where a cut-off frequency is approximately 64 MHz. Actually, a waveform having a frequency component of equal to or greater than 100 MHz, which is equivalent to a crosstalk noise, is input from the electrode pads 54 connected to the spin torque oscillator 72, and a voltage applied to the spin torque oscillator is measured using evaluation electrodes provided at both ends of the spin torque oscillator. Then, the input waveform is attenuated to the extent of being immaterial. That is, the crosstalk noise is removed by the low pass filter 56.

As described above, according to the magnetic head of the HDD according to the second embodiment, a bias voltage of the spin torque oscillator may be maintained in a stable state without being affected by a crosstalk noise, regardless of a recording frequency of the recording head, and it is possible to stably perform recording based on stable microwave oscillation.

A crosstalk noise is generated between wirings 45a for a recording current and wirings 45a for electrifying the spin torque oscillator 72 on an HGA 30. For this reason, it is possible to cut off a crosstalk noise before the crosstalk noise reaches a microwave oscillator by forming the low pass filter 56 between the electrode pads 54 of the magnetic head connected to wirings of a flexure and the microwave oscillator, which leads to a more effective result.

Since an electrode of a reproducing head is a capacitor and a conductor of a heater is a resistive film within a magnetic head, a capacitor and a resistor configuring a low pass filter are formed at the same time when the electrode and the conductor are formed, and thus it is possible to easily fabricate the low pass filter into the magnetic head. Since the level of a crosstalk noise is low at a low frequency, as described above, there is no problem. However, as the frequency becomes higher, a problem occurs. Accordingly, a cut-off frequency of the low pass filter is set equal to or less than 500 MHz or, preferably, equal to or less than 100 MHz. In this way, it is possible to cut off noise so as not to disturb a bias voltage of the microwave oscillator.

### Third Embodiment

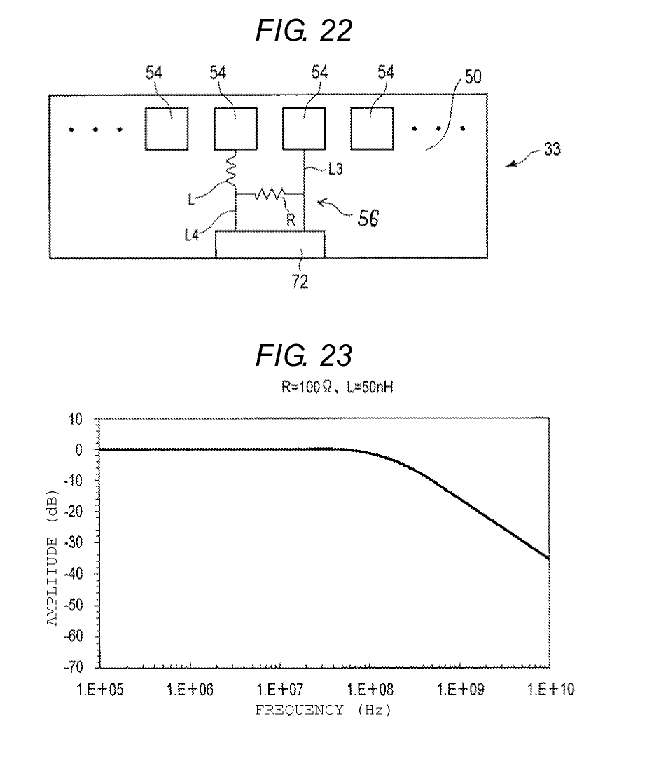

FIG. 22 schematically illustrates a magnetic head of an HDD according to a third embodiment. According to this embodiment, a low pass filter 56 is formed within a slider 50 of a magnetic head 33. A plurality of electrode pads 54 are provided at an end of the slider 50 on a trailing side. The magnetic head 33 includes a reproducing head, a recording head, and a spin torque oscillator 72, and the spin torque oscillator 72 is electrically connected to the electrode pads 54 through wirings L3 and L4. The low pass filter 56 is formed between the spin torque oscillator 72 and the electrode pad 54 within the slider 50. In this embodiment, the low pass filter 56 includes a resistor R and an inductor L, and is connected to the wirings L3 and L4.

The resistor R and the inductor L comprising the low pass filter 56 are fabricated together in a wafer process when creating a head unit of the magnetic head 33. For example, the resistor R is formed of the same layer as a conductor layer for forming a floating control heater, and the inductor L is formed at the same time when a magnetic core, such as a main magnetic pole and a write shield, and a recording coil are formed. Values of the resistor R and the inductor L which are formed in this manner are R=100Ω and L=50 nH, respectively.

FIG. 23 illustrates frequency characteristics of the low pass filter 56 configured in this embodiment. A cut-off frequency of the low pass filter 56 is equal to or less than 160 MHz. For this reason, the low pass filter 56 may drastically reduce crosstalk noise from wirings for a recording current. Crosstalk noise from the wirings for a recording current is measured between the low pass filter 56 and the spin torque oscillator 72, and the crosstalk noise is at a level which is almost unobservable.

As described above, according to the magnetic head of the HDD according to the third embodiment, a bias voltage of the spin torque oscillator may be maintained in a stable state without being affected by a crosstalk noise, regardless of a recording frequency of the recording head, and it is possible to stably perform recording based on stable microwave oscillation.

Since a floating control heater is a resistor and a coil of a recording head is an inductor within a magnetic head, the resistor R and the inductor L are formed at the same time as when the heater and the coil are formed, and thus it is possible to easily form a low pass filter.

Meanwhile, in the second and third embodiments described above, the configurations of the HGA and the HDD are the same as those in the first embodiment described above. Accordingly, in the second and third embodiments, it is possible to obtain: a microwave assist type magnetic head capable of preventing the mixing of high-frequency noise into a microwave oscillator regardless of a recording frequency of a recording head, and which is capable of stably oscillating and recording; a head gimbal assembly including the magnetic head; and a disk device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the materials, shapes and sizes of structural elements of a head unit may be changed if necessary. In a magnetic disk device, the number of magnetic disks and magnetic heads may be increased if necessary, and the size of the magnetic disk may be variously selected.

What is claimed is:

1. A magnetic head comprising:
a main magnetic pole that applies a recording magnetic field to a recording layer of a recording medium;
a recording coil configured to generate a magnetic field in the main magnetic pole;
a microwave oscillator that is disposed in a vicinity of the main magnetic pole;
a first wiring electrically connected to the recording coil;
a second wiring electrically connected to the microwave oscillator; and
a low pass filter that is electrically connected to the second wiring.

2. The head according to claim 1, wherein
the low pass filter is formed of a circuit that includes a capacitor.

3. The head according to claim 2, wherein
a cut-off frequency of the low pass filter is equal to or less than 500 MHz.

4. The head according to claim 2, further comprising:
a reproducing head that includes a first shield layer, a second shield layer, and an insulating layer located between the first and second shield layers.

5. The head according to claim 4,
wherein the capacitor includes a first electrode which is the same layer as the first shield layer, a second electrode which is the same layer as the second shield layer, and a dielectric layer which is located between the first and second electrodes and which is the same layer as the insulating layer.

6. The head according to claim 1, wherein
the low pass filter is formed of a circuit that includes an inductor.

7. The head according to claim 1, wherein the low pass filter is electrically connected to the microwave oscillator.

8. The head according to claim 1, further comprising:
a slider having a facing surface that faces the recording layer,
wherein the main magnetic pole, the recording coil, the microwave oscillator, and the low pass filter are provided within the slider.

9. The head according to claim 8, further comprising:
a heater provided within the slider, and configured with a resistive element that heats the slider.

10. The head according to claim 9,
wherein the low pass filter includes a resistor formed of the same layer as the resistive element.

11. A head gimbal assembly comprising:
a supporting plate that has a tip portion;
a wiring member that includes a thin metal plate, an insulating layer laminated on the thin metal plate, and a conductive layer that is laminated on the insulating layer and has a plurality of wirings, including a first wiring and a second wiring, formed therein, the wiring member being attached to the supporting plate and including a gimbal portion facing the tip portion of the supporting plate; and
a magnetic head mounted on the gimbal portion and electrically connected to the first and second wirings of the wiring member, the magnetic head including
a main magnetic pole that applies a recording magnetic field to a recording layer of a recording medium,
a recording coil configured to generate a magnetic field in the main magnetic pole and electrically connected to the first wiring,
a microwave oscillator that is disposed in a vicinity of the main magnetic pole and electrically connected to the second wiring, and
a low pass filter that is electrically connected to the second wiring.

12. The head gimbal assembly according to claim 11, wherein the low pass filter is formed of a circuit that includes a capacitor.

13. The head gimbal assembly according to claim 12, wherein the magnetic head further comprises:
a reproducing head that includes a first shield layer, a second shield layer, and an insulating layer located between the first and second shield layers.

14. The head gimbal assembly according to claim 11, wherein the low pass filter is formed of a circuit that includes an inductor.

15. The head gimbal assembly according to claim 11, wherein the low pass filter is electrically connected to the microwave oscillator.

16. The head gimbal assembly according to claim 11, wherein the magnetic head further comprises:
a slider having a facing surface that faces the recording layer,
wherein the main magnetic pole, the recording coil, the microwave oscillator, and the low pass filter are provided within the slider.

17. The head gimbal assembly according to claim 16, wherein the magnetic head further comprises:
a heater provided within the slider, and configured with a resistive element that heats the slider.

18. A disk device comprising:
a disk-like recording medium;
a driving unit configured to rotate the recording medium; and
a head gimbal assembly including
a supporting plate that has a tip portion;
a wiring member that includes a thin metal plate, an insulating layer laminated on the thin metal plate, and a conductive layer that is laminated on the insulating layer and has a plurality of wirings, including a first wiring and a second wiring, formed therein, the wiring member being attached to the supporting plate and including a gimbal portion facing the tip portion of the supporting plate;
a magnetic head mounted on the gimbal portion and electrically connected to the first and second wirings of the wiring member; and
a low pass filter mounted on the gimbal portion and electrically connected to the magnetic head and the second wiring,
wherein the magnetic head includes a main magnetic pole that applies a recording magnetic field to a recording layer of a recording medium, a recording coil configured to generate a magnetic field in the main magnetic pole and electrically connected to the first wiring, and a microwave oscillator that is disposed in a vicinity of the main magnetic pole and electrically connected to the second wiring.

19. The disk device according to claim 18, wherein
the magnetic head includes a slider having a facing surface facing the recording layer, and a plurality of electrode pads electrically connected to the first and second wirings,
the main magnetic pole, the recording coil, and the microwave oscillator are provided within the slider, and
the low pass filter is electrically connected to the electrode pads.

20. The disk device according to claim 19, wherein the low pass filter is electrically connected to the microwave oscillator and has a cut-off frequency equal to or less than 500 MHz.
